(19) United States
(12) Patent Application Publication
(10) Pub. No.: US 2018/0105413 A1
(43) Pub. Date: Apr. 19, 2018

(54) DYNAMIC TOUCHSCREEN FUEL SELECTION

(71) Applicant: Wayne Fueling Systems LLC, Austin, TX (US)

(72) Inventors: Henry Fieglein, Cedar Park, TX (US); Scott R. Negley, III, Austin, TX (US); John Joseph Morris, Austin, TX (US); Bengt I. Larsson, Skivarp (SE); Thomas Cerovski, Cedar Park, TX (US); Steve Belt, Pflugerville, TX (US)

(73) Assignee: Wayne Fueling Systems LLC, Austin, TX (US)

(21) Appl. No.: 15/786,421

(22) Filed: Oct. 17, 2017

Related U.S. Application Data
(60) Provisional application No. 62/409,076, filed on Oct. 17, 2016.

(51) Int. Cl. B67D 7/14; B67D 7/08; G06Q 20/20; G06F 21/44; G07F 13/02; G06F 3/041

(52) U.S. Cl. CPC B67D 7/14; B67D 7/08; G06Q 20/204; G07G 1/14; G07F 13/025; G06F 3/0412; G06F 21/44

(57) ABSTRACT

Fuel dispensers, systems, and methods are provided for allowing a user to dynamically create a customized fuel blend, also referred to as a fuel mixture. In an exemplary embodiment, a fuel dispenser is provided having an interactive display, such as a touchscreen display, and a data processor that can perform operations that enable any one or more of replacing PTS buttons, integrating additive pumps to combine fuel mixtures and additives, mixing fuels and additives, calculating fuel mixture prices, and allowing a user to customize fuel mixtures. The application of the interactive display and the control module, as well as other components, can facilitate allowing a user to create customized fuel mixtures, while minimizing changes to standard communication protocol associated with components such as, e.g., a point-of-sale (POS), a forecourt controller, and a fuel controller that can control dispensing of fuel.

### CROSS-REFERENCE TO RELATED ACTIONS

This application claims priority to U.S. Provisional Application No. 62/409,076 filed on Oct. 17, 2016 and entitled “Dynamic Touchscreen Fuel Selection,” which is hereby incorporated by reference in its entirety.

### FIELD

Methods, devices, and systems are provided for enabling selection and delivery of customized fuel blends in a fuel dispenser.

### BACKGROUND

Typically, fuel dispensers utilize Push to Select (PTS) buttons to allow a user to select a desired fuel grade to be delivered to a vehicle. Current fuel dispensers that utilize PTS buttons include an electronics compartment and a pump compartment. The pump compartment houses a pump configured to pump fuel from a fuel tank or other reservoir, as well as one or more meters that can be configured to monitor fuel flow. The electronics compartment includes PTS buttons for selecting a desired fuel, a fuel controller for facilitating the dispensing of the fuel, and an output terminal coupled to the fuel controller for displaying a total cost and volume of fuel dispensed. The electronics compartment also includes a payment terminal that interfaces with the user for facilitating payment for fuel and other items. In some cases, the payment terminal can be separate from the fuel dispenser.

A user can provide payment information (e.g., credit card information) using the payment terminal, and payment information can be delivered via a forecourt controller to a point-of-sale (POS) system for verification. Once the payment information is verified, the POS can notify the fuel controller, which can initiate fueling. The forecourt controller can also deliver data corresponding to unit prices of available fuel grades to the fuel controller via the forecourt controller. The user can select a fuel grade using one of the PTS buttons. The PTS button sends a signal to the fuel controller, which will activate a pump to dispense the desired fuel. As fuel is dispensed, the meter(s) monitor an amount of fuel that has been dispensed, and the fuel controller calculates a running cost of the fuel based on the unit price of the selected fuel grade and the amount of fuel that has been dispensed. The fuel controller delivers data characterizing the running cost and the amount of fuel that has been dispensed to the output terminal to provide the information to the user.

PTS fuel grade selection buttons on the dispenser have several limitations related to reliability, costs, and versatility. Since PTS buttons are physical mechanical buttons with moving parts, they are subject to failure which tends to result in increased cost. Additionally, because of the physical space that a button occupies, a limited number of buttons can be present on a single fuel dispenser. A typical fuel dispenser will have three PTS buttons on one side of the dispenser for allowing a user to select from one of three octane grades, regular (usually 87 octane), mid-grade (usually 89 octane), and premium (usually 92 or 93 octane). Some dispensers also contain an additional PTS button for an ethanol blend, and/or one or more PTS buttons for additives. Each PTS button has a static label that indicates the grade, and utilizes an electro-mechanical switch that transmits a signal to the fuel controller for activating fuel delivery. In some cases, pricing information corresponding to each fuel grade can be represented on a display that is on, or near, each PTS button. The number of buttons present on a particular dispenser will limit the selection options for a user, and can limit pricing information that can be displayed for each fuel grade.

There remains a need for improved systems and methods that enable a user to create customized fuel blends in a fuel dispenser.

### SUMMARY

Fuel dispensers, systems, and methods are provided for allowing a user to dynamically create a customized fuel blend, also referred to as a fuel mixture. In one embodiment, a fuel dispenser is provided that includes a pump compartment having at least one fuel pump disposed therein and configured to dispense fuel, a fuel controller in operative communication with the pump compartment for controlling the at least one fuel pump, and a payment terminal. The payment terminal can include an interactive display that can be configured to receive input thereon to enable a user to create a customized fuel blend. The payment terminal can also include a control module that can be configured to receive data that characterizes the customized fuel blend created by the user, to obtain pricing information relating to components of the customized fuel blend, compute a unit price for the customized fuel blend using the pricing information, generate instructions for creating the customized fuel blend, and transmit the instructions to the fuel controller for dispensing the customized fuel blend.

The fuel dispenser can vary in a number of ways. For example, the interactive display can include a touchscreen. As another example, the control module can be configured to receive data characterizing payment information from the interactive display, and to deliver the data characterizing payment information to a point-of-sale system for verification. As yet another example, the control module can be configured to deliver data characterizing the unit price to the interactive display to update a graphical element of a graphical user interface rendered on the interactive display to display the unit price. In some implementations, the control module can be configured to obtain the pricing information from a point-of-sale system. In other implementations, the payment terminal can be configured to receive information from the fuel controller during the dispensing of the customized fuel blend, and to display data characterizing a current total price of the customized fuel blend dispensed.

In another aspect, a method for delivering fuel from a fuel dispenser is provided. The method can include displaying on an interactive display of a fuel dispenser at least one first graphical object for specifying a fuel blend, receiving data characterizing a user input that identifies the fuel blend, and determining instructions for creating the fuel blend based on the received data, wherein the instructions identify at least two components of the fuel blend. The method can also include computing a unit value of the fuel blend using value information related to each of the at least two components of the fuel blend, displaying on the interactive display at least one second graphical object comprising the computed unit value, and transmitting the instructions to a fuel controller of the fuel dispenser for creating the fuel blend. The fuel controller can be configured to control dispensing of the fuel blend from the fuel dispenser.

The method can vary in a number of ways. For example, the method can include obtaining the value information from a point-of-sale system. As another example, the unit value of the fuel blend can be computed by a control module of a payment terminal of the fuel dispenser. As yet another example, the method can include transmitting data characterizing the unit value of the fuel blend from a control module of a payment terminal of the fuel dispenser to the fuel controller. In some implementations, at least one of the displaying, receiving, determining, and transmitting can be performed by at least one data processor forming part of at least one computing system. In other implementations, the instructions for creating the fuel blend can include percentages of the at least two components of the fuel blend. As another example, the at least one graphical object can include three graphical objects that represent three different fuel grades, each fuel grade having a different octane level.

In another aspect, a non-transitory computer program product that includes computer readable instructions is provided. When executed by at least one data processor forming part of at least one computing system, the computer readable instructions can implement operations including displaying on an interactive display of a fuel dispenser at least one first graphical object for specifying a fuel blend, receiving data characterizing a user input that identifies the fuel blend, and determining instructions for creating the fuel blend based on the received data, wherein the instructions identify at least two components of the fuel blend. The operations can also include computing a unit value for the fuel blend using value information related to the at least two components of the fuel blend, displaying on the interactive display at least one second graphical object for accepting the computed unit value, transmitting the instructions to a fuel controller in the fuel dispenser for creating the fuel blend. The fuel controller can be configured to control dispensing of the fuel blend from the fuel dispenser.

The non-transitory computer program can vary in a number of ways. For example, when executed, the instructions can implement operations that include obtaining the value information a point-of-sale system. As another example, the operations can include comprising transmitting data characterizing the unit value of the fuel blend to the fuel controller. As yet another example, the at least one graphical object can be three graphical objects that represent three different fuel grades, each fuel grade having a different octane level. In some implementations, the instructions for creating the fuel blend can include a percentage of the at least two components of the fuel blend. In other implementations the unit value of the fuel blend can be computed by a control module of a payment terminal of the fuel dispenser.

### BRIEF DESCRIPTION OF THE DRAWINGS

FIG. 1A is a side perspective view of one embodiment of a fuel dispenser;

FIG. 1B is a front perspective view of the fuel dispenser shown in FIG. 1A;

FIG. 2 is a diagram showing internal components of the fuel dispenser of FIGS. 1A and 1B;

FIG. 3 is a diagram of one embodiment of data flow for dispensing fuel;

FIG. 4 is a schematic of one embodiment of a graphical user interface (GUI) for enabling a user to create a customized fuel blend;

FIG. 5 is a schematic of the GUI of FIG. 4 with a customized fuel blend created by a user; and

FIG. 6 is a schematic of another embodiment of a GUI for enabling a user to create a customized fuel blend.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Fuel dispensers, systems, and methods are provided for allowing a user to dynamically create a customized fuel blend, also referred to as a fuel mixture. In an exemplary embodiment, a fuel dispenser is provided having an interactive display, such as a touchscreen display, and a control module that can perform operations that enable any one or more of replacing PTS buttons, integrating additive pumps to combine fuel mixtures and additives, mixing fuels and additives, calculating fuel mixture prices, and allowing a user to customize fuel mixtures.

As explained above, current fuel dispensers that utilize Push to Select (PTS) buttons to allow a user to select a desired fuel grade have several limitations related to reliability, costs, and versatility. The PTS buttons operate in conjunction with fuel controller to allow the fuel dispenser to dispense a desired fuel grade. Although current fuel controllers are capable of controlling the dispensing of a wide variety of fuel mixtures, the number of different fuel grades and/or additives that the fuel dispenser can dispense is limited by the number of PTS buttons included on the fuel dispenser. The application of the interactive display and the control module, in conjunction with other components of a fuel dispenser, can facilitate allowing a user to create customized fuel mixtures, while minimizing changes to standard communication protocol associated with components such as, e.g., a point-of-sale (POS) that can be configured to manage certain payment functionality of the fuel dispenser, a forecourt controller that can be configured to manage one or more fuel dispensers, and a fuel controller that can control dispensing of fuel, as discussed in more detail below.

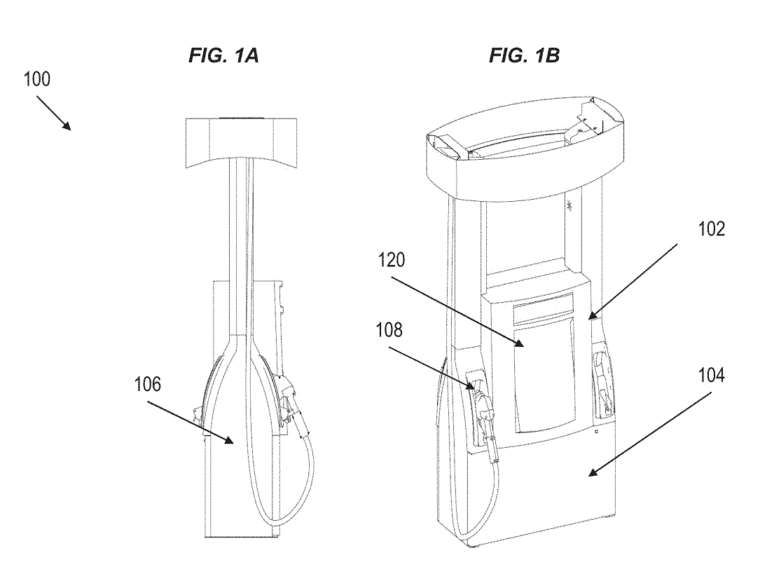

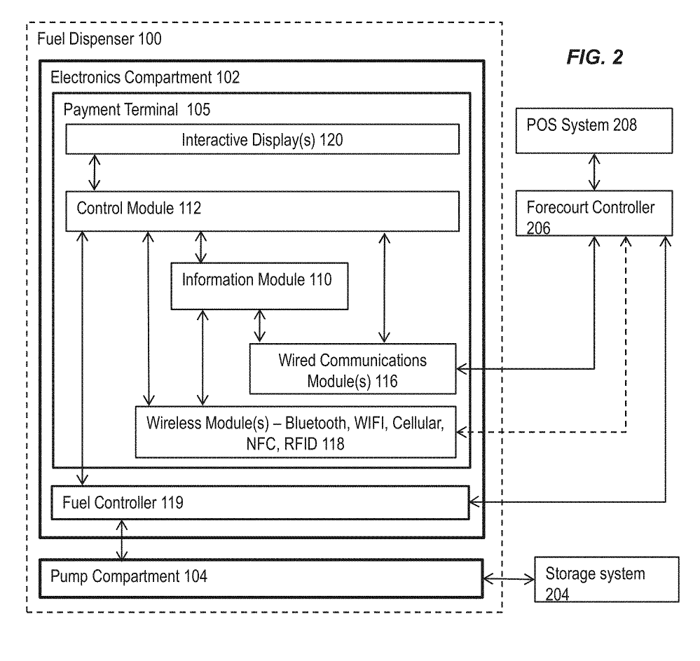

FIGS. 1A and 1B illustrate one embodiment of a fuel dispenser 100, and FIG. 2 illustrates components of the fuel dispenser. In general, the fuel dispenser 100 includes an electronics compartment 102 and a pump compartment 104. The pump compartment 104 houses a pump configured to pump fuel from a fuel tank or other reservoir, as well as one or more meters that can be configured to monitor fuel flow, flow of fuel additives, and/or flow of other components of the fuel. The pump compartment 104 can also include other components to facilitate fuel dispensing and mixing, such as motors and valves, a strainer/filtering system, a vapor recovery system, and the like. The pump compartment 104 is isolated from the electronics compartment 102 within the fuel dispenser 100 to facilitate safety, security, and/or maintenance, as will be appreciated by a person skilled in the art. Fuel is thus not allowed to flow from the pump compartment 104 to the electronics compartment 102 and instead flows from the pump compartment 104 through hoses 106 to nozzles 108 for dispensing. As will be appreciated by a person skilled in the art, the nozzles 108 are each configured to dispense fuel from the fuel dispenser 100 as pumped therefrom by the pump.

The electronics compartment 102 houses electronics for facilitating payment for fuel and for facilitating the dispensing of the fuel. For example, the electronics compartment 102 can include a fuel controller 119 that, at least in some implementations, includes a data processor, memory, and storage forming part of at least one computing system. The fuel controller 119 is configured to control dispensing of the fuel from the pump compartment 104. The electronics compartment 102 also includes a payment terminal 105 that is configured to provide a user with one or more options to create a desired fuel mixture, receive instructions characterizing the desired fuel mixture, receive payment information and/or user identification information from a user, transmit and receive the payment information and/or the user identification information with a POS system via a forecourt controller 206, and deliver fueling instructions to the fuel controller 119 to dispense fuel. The payment terminal 105 can also be configured to provide a user with information related to a status of fueling. For example, the payment terminal can display an amount of fuel that has been dispensed, and a corresponding fuel cost as the fuel mixture is dispensed.

The payment terminal 105 can be configured to facilitate communication between a user and the fuel controller 119, and can include an interactive display 120 and an information module 110. The information module 110 can, at least in some implementations include a data processor, memory, and storage, forming part of at least one computing system. The payment terminal 105 can also include one or more wired communication modules 116 and/or wireless communication modules 118 and a control module 112 that, at least in some implementations includes a data processor, memory, and storage, forming part of at least one computing system. The communication modules 116, 118 can function to allow data to be transmitted to and from various components within the payment terminal 105 via wired and/or wireless communication, respectively. For example, the communication modules 116, 118 can be configured to transmit and receive signals that can characterize, e.g., payment information, user identification information, and/or information regarding a desired fuel selection, via wired and/or wireless communications, respectively. The wireless communication module 118 can include, e.g., a transceiver for communicating via Bluetooth protocol, cellular protocol, WI-FI protocol, near field communication (NFC), and/or a radio frequency identification (RFID) protocol. Wired and/or wireless communication via the communication modules 116, 118 can be according to any of a variety of communication protocols, e.g., TCP/IP, etc., as will be appreciated by a person skilled in the art.

The interactive display 120, which can be, or can include, a touchscreen, can facilitate providing a user with a much broader array of choices than could be provided using PTS buttons. For example, a user can customize the fuel mixture based on octane levels, ethanol blends, additives, and the like, or the user can select a pre-configured mixture. The interactive display 120 can be operably coupled to the control module 112 which can be used to control, dynamically rearrange, and/or update a graphical user interface (GUI) rendered on the display 120. The display 120 can be configured to show information (e.g., media content, fuel selection options, payment information, user identification information, etc.) in the form of one or more graphical elements, or graphical objects, receive input (e.g., instructions for a desired fuel mixture, user identification information, payment information, etc.) thereon, and can deliver data characterizing the input to the control module 112 to be processed. For example, the control module 112 can receive data characterizing available fuel mixture ingredients including, e.g., additives that are available, octane levels, ethanol blends, etc. from the fuel controller 119. The control module 112 is discussed in more detail below. As an example, the display 120 can prompt the user with various options and information such as common premixed fuel options, fuel costs, fuel mixture ingredients and additives that are available, octane levels, ethanol blends, an option to input vehicle information for a custom fuel mixture, available payment methods, and the like. Some examples of information that the display 120 can receive from the user are: total cost, desired fuel volume, desired fuel mixture, desired additives, an initiate fueling command, and a terminate fueling command. In some implementations, the user can provide user information, such as user preferences, contact information, etc., and/or information regarding a device that will consume the fuel, such as vehicle make, model, mileage, and the like. The user can also be provided with a recommend fuel blend which they can choose to select.

To facilitate payment, the information module 110 can be configured to receive input such as, e.g., user identification information and/or payment information, and deliver the information to the control module 112. For example, the information module 110 can include a card reader such as a magnetic strip card reader, a chip reader, a barcode and/or QR code scanner, and/or a NFC contactless card reader for receiving payment information and/or user identification information. As an example, the card reader can scan a loyalty rewards card and receive a loyalty rewards identifier. The loyalty rewards identifier can be delivered to the control module 112, which can use the loyalty rewards identifier to determine or obtain user identification information and/or a pre-set payment method. For example, the control module 112 can use the wired and/or wireless communication modules 116, 118 to access a loyalty service within a network cloud. The control module 112 can provide data characterizing the loyalty rewards identifier to the loyalty rewards service to access a user account that can include user identification information, user preferences, a loyalty rewards status, and/or a preset payment method. The loyalty service can deliver data to the control module 112 characterizing the user identification information, user preferences, and/or preset payment methods corresponding to the loyalty rewards identifier. For example, user preferences can include default fuel grade selection that the user has set.

In some embodiments, the information module 110 can include an image sensor for acquiring images of facial features of the user, barcode and/or QR code information (e.g., to scan a loyalty rewards card), vehicle features (e.g., vehicle make, model, color, etc.), license plate number, non-facial body features, and the like, which can be used as user identification information. As another example, the information module can include a palm reader and or/fingerprint reader which can scan a palm and/or finger of the user to obtain user identification information. In some embodiments, the user identification information can be associated with a loyalty rewards identifier automatically. Accordingly, in some embodiments, a pre-determined payment method, and user preferences, can be determined based on user identification information.

As shown in FIG. 2, the information module 110 can be operably coupled to the wired communication module 116 and/or the wireless communication module 118. The wired and wireless communication modules 116, 118 can allow the information module 110 to send and receive payment information and/or user identification information to and from a mobile device such as a smart phone, tablet, laptop, and the like, that is in electronic communication with the information module 110 via the wired and/or wireless communication modules 116, 118. For example, in some cases, a loyalty identifier can be transferred to the information module via a NFC and/or Bluetooth communication. Although the wireless communication module 118 is shown to be located within the payment terminal, the wireless communication module 118 can be located elsewhere on, within, or in the vicinity of, the fuel dispenser 100. For example, the wireless communication module 118 can be mounted on top of the fuel dispenser, which can facilitate retrofitting the wireless communication module 118 to existing fuel dispensers and/or facilitate repair, upgrade, or other maintenance of the communication module 118, as described in U.S. patent application Ser. No. 15/182,201 filed on Jun. 14, 2016 and entitled “Methods and Devices for Fuel Dispenser Electronic Communication,” which is hereby incorporated by reference in its entirety.

The addition of the interactive display 120, which enables customized fuel mixtures to be selected by the user, can present certain challenges regarding payment. In particular, pricing for the customized fuel mixture may not be available prior to identifying the desired fuel mixture. Therefore, in some embodiments, a price of the fuel mixture can be determined when the fuel mixture is identified by a user so that it can be provided to the user prior to delivering the fuel. Additionally, instructions for creating the desired fuel mixture can be communicated to the fuel controller 119 so that appropriate components of the fuel mixture can be mixed and dispensed. Accordingly, the control module 112 can function to determine a price of the desired fuel mixture, and can facilitate communication between the user and the fuel controller 119 such that fuel can be dispensed.

The control module 112 can receive the instructions for the desired fuel mixture, payment information, and user identification information from the interactive display 120 and/or the information module 110. The control module 112 can provide a signal characterizing the desired fuel mixture, payment information, and user identification to the forecourt controller 206 via the wired and/or wireless communication modules 116, 118. The forecourt controller 206 can deliver the payment information, user identification information, and information characterizing the desired fuel mixture to a point-of-sale (POS) system 208. The POS system 208 can verify the payment information and can provide pricing information characterizing a price, or value, of each component of the desired fuel mixture. For example, the POS system 208 can deliver data characterizing a unit price for each component of the desired fuel mixture to the control module 112 via the forecourt controller 206. Alternatively, in some embodiments, the pricing information can be stored in the forecourt controller 206, and the forecourt controller 206 can deliver data characterizing a unit price for each component of the desired fuel mixture to the control module 112. In some embodiments, the pricing information can be delivered from the forecourt controller 206 to the control module 112 via the fuel controller 119.

In some embodiments, data characterizing a loyalty rewards identifier can be delivered to the POS system 208. The POS system 208 can access a loyalty service within a network cloud. The POS system 208 can also provide data characterizing the loyalty rewards identifier to the loyalty rewards service to access a user account that can include user identification information, user preferences, a loyalty rewards status, and/or a preset payment method. The POS system 208 can deliver data to the control module 112 characterizing the user identification information, user preferences, and/or preset payment methods corresponding to the loyalty rewards identifier.

The control module 112 can use the pricing information from the forecourt controller 206, or the POS system 208, in conjunction with the instructions for the desired fuel mixture to determine a unit price for the desired fuel mixture. In some cases, the control module 112 can calculate unit prices corresponding to various payment methods. For example, the control module 112 can calculate a unit price corresponding to cash payments, and a unit price corresponding to credit card payments. All communication regarding pricing within the fuel dispenser 100, and between the fuel dispenser 100, the forecourt controller 206, and the POS system 208 are performed securely. For example, the pricing information from the forecourt controller 206, or POS system 208, can be signed for the control module 112 and/or fuel controller to authenticate.

Once the fuel price has been calculated, the control module 112 can deliver a signal to the display 120 to update graphical elements on the display 120 to show the calculated unit price of the fuel mixture, and to request confirmation to proceed from the user. In some cases, the user can be eligible for a price discount, depending on a current loyalty rewards status. The control module 112 can deliver a signal to the display 120 to update graphical elements on the display 120 to allow the user to apply the discount to the calculated unit price of the fuel mixture. The control module 112 can also translate pricing information, the calculated price of the desired fuel mixture, and instructions for delivering the customized fuel mixture, such as instructions relating to the types of fluids to be delivered, and specific amounts of each component, into commands that can be understood by the fuel controller 119. For example, the user might select a “high octane” fuel option, and the control module 112 can convert that into amounts of individual components required to create the desired fuel mixture. Once all of the data has been translated, at least some of the data related to fuel mixture and fuel delivery can be provided to the fuel controller 119 in the proper language. In some embodiments, the fuel controller 119 can translate the instructions from the control module 112 into instruction that meters within the pump compartment 104 can understand. For example, the control module 112 might deliver fueling instructions characterizing a desired “98 octane” fuel grade to the fuel controller 119. The fuel controller 119 can translate the fueling instructions into commands characterizing fuel components required to make the 98 octane fuel mixture. For example, the translated instructions can include types of components, unit price per component, amounts of each component, and/or flow rates of each component such that the desired 98 octane fuel mixture can be dispensed and metered properly.

The user can confirm, or accept the price of the fuel mixture, which can result in the fuel controller 119 being activated. For example, the control module 112 can receive data characterizing acceptance of unit price of the fuel mixture, and can deliver an activation command to the fuel controller 119 to activate the fuel controller 119. The fuel controller 119 can deliver a signal to the forecourt controller 206 to update the status of the transaction, and the provide information regarding fueling so that an attendant can monitor the status of the fuel dispenser 100. In some embodiments, if the user applies a price discount, the control module 112 can deliver data characterizing the discounted fuel price, or acceptance of the discounted fuel price, along with instructions for delivering the desired fuel mixture, to the POS system 208 via forecourt controller 206. The forecourt controller 206 can deliver data characterizing the discounted fuel price along with the instructions for delivering the desired fuel mixture to the fuel controller 119.

Once the price has been accepted, the user can enter a command to initiate fueling. In some embodiments, the command can be entered on the display 120. The initiation command can be received by the control module 112, where it can be translated and sent to the fuel controller 119. The fuel controller 119 can then activate the pumps within the pump compartment 104 to dispense the desired fuel mixture. Alternatively, the display 120 can provide an indication to the user that they may begin fueling. In some embodiments, the initiation command can be entered as a result of a user action, such as removing the nozzle 108 from the dispenser and/or depressing a lever on the nozzle 108.

As shown in FIG. 2, the pump compartment 104 can be coupled to a storage system 204. The storage system 204 can house components, also referred to as ingredients, which can be used to make the desired fuel mixture. For example, gasoline (also known as petrol) is primarily comprised of processed crude oil, however, there are a number of additives that can be included. Those additives can include fuel stabilizers, detergents, dyes, oxygen-bearing compounds, and the like. Each component can be stored in a separate storage tank for delivery to the dispenser. One or more pumps within the pump compartment 104 can draw specified quantities of the components from the storage system 204. The components can be mixed and dispensed from the fuel dispenser 100.

During fueling, the control module 112 can obtain information from the fuel controller 119 regarding the status of the fueling process. For example, the fuel controller 119 can provide information regarding a volume of fuel dispensed and a total cost of the dispensed fuel to the control module 112. The control module 112 can translate that information into data that can be understood by the display 120, and can send it to the display 120 for the user to see.

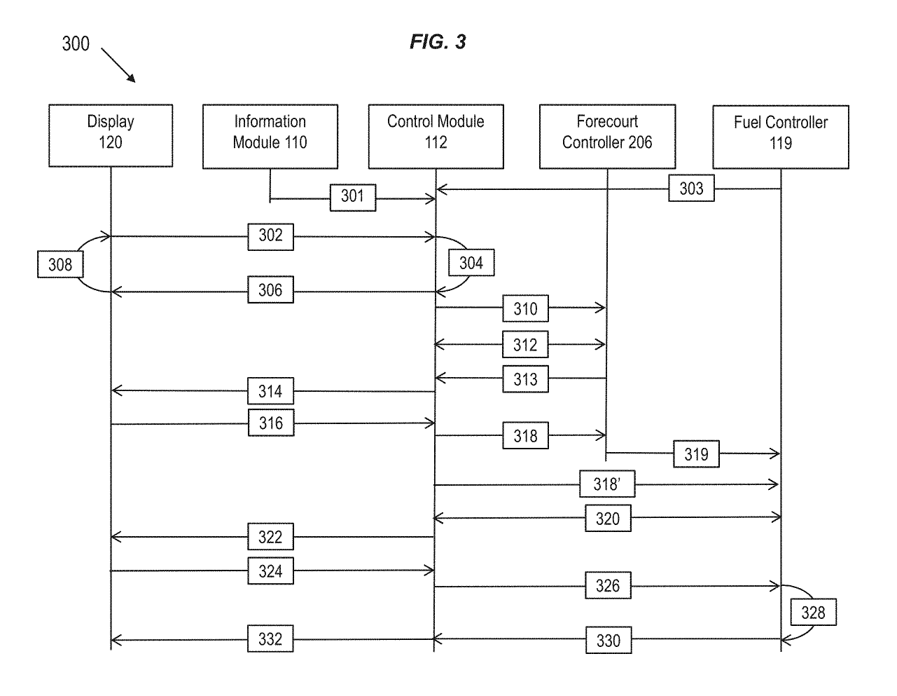

FIG. 3 shows a diagram 300 that illustrates exemplary data flow that can occur between the display 120, the information module 110, the control module 112, the forecourt controller 206, and fuel controller 119. In the illustrated embodiment, the control module 112 can receive data 303 characterizing available components for creating a fuel mixture from the fuel controller 119. The information module 110 can deliver data 301 characterizing payment information, user identification information, and/or a loyalty rewards identifier to the control module 112. Although not illustrated, the control module 112 can deliver data to the display 120 to prompt the user to input supplementary payment information, user identification information, and/or to select components of the desired fuel mixture.

The display 120 can receive input data 302 from the user, and can send it to the control module 112. The data 302 can include information regarding a desired fuel mixture, payment information, and/or user identification information. For example, the data 302 can characterize a specified octane grade for the desired fuel mixture. Depending on the selection, the octane grade may require a custom blend of available grades in the storage system 204. As another example, the data 302 can include supplementary payment information and/or user identification information. In some cases, if the information module 110 does not provide data 301 to the control module 112, the data 302 can include all of the payment information and/or user identification information.

The control module 112 can compute 304 a response and can send data 306 characterizing options back to the display 120. The options can include more fuel mixture choices and/or a prompt input further payment information and/or user identification information.

The display 120 receives the data 306 from the control module 112, displays data 308 characterizing the data 306 from the control module, and receives input data 302 from the user. The user input data 302 is subsequently sent back to the control module 112.

The cycle of the user entering data 302 into the display 120, the display 120 sending the data 302 to the control module 112, the control module 112 subsequently computing 304 a response and sending data 306 back to the display 120 to update graphical elements, or graphical objects, to display the data 308, can continue until the desired fuel mixture is identified, or until some predetermined maximum time limit is reached.

Once the desired fuel mixture has been determined, the control module 112 can deliver data 310 characterizing the desired fuel mixture, payment information, and/or user identification to the forecourt controller 206 via the wired and/or wireless communication modules 116, 118. The forecourt controller 206 can deliver the data 310 characterizing the payment information, user identification information, and/or information characterizing the desired fuel mixture to the POS system 208 (shown in FIG. 2). The POS system 208 can authenticate and verify the payment information and/or can provide pricing information characterizing a price, or value, of each component of the desired fuel mixture to the forecourt controller 206. The forecourt controller 206 can deliver data 312 characterizing the pricing information to the control module 112. The data 312 can be authenticated between the control module 112 and the POS system 208 via the forecourt controller 206. Once the payment information has been authenticated, the forecourt controller 206 can send a signal 313 to the control module 112 that allows the control module 112 to active the fuel pumps via the fuel controller 119. The control module 112 can use the pricing information to calculate a unit price, or value, of the desired fuel mixture.

The control module 112 can deliver data 314 characterizing the calculated unit price, or value, of the desire fuel mixture to the display 120, which can update a graphical element, or a graphical object, of GUI to display the unit price and can prompt the user to accept or decline the calculated unit price, and to activate the fuel controller. The user can then input data 316 to accept the displayed price and deliver an activation command to activate the fuel controller 119. The data 316 can be delivered to the control module 112. The control module 112 can translate one or more of the calculated unit price of the desired fuel mixture, the activation command, as well as the pricing information previously obtained from the forecourt controller 206, along with instructions for delivering the desired fuel mixture, such as instructions relating to the types of fluids to be delivered, flow rates for each fluid, and percentages of each fluid, or component, that makes up the desired fuel mixture, into commands that can be understood by the fuel controller 119. As described above, in some cases, the user can be eligible for a price discount, depending their loyalty rewards status. If the user applies the price discount, the control module 112 can deliver data 318 characterizing the discounted fuel price, or acceptance of the discounted fuel price, along with instructions for delivering the desired fuel mixture, to the forecourt controller 206 and to the POS system 208. The forecourt controller 206 can deliver data 319 characterizing the discounted fuel price along with the instructions for delivering the desired fuel mixture to the fuel controller 119. The fuel controller 119 can translate the instructions for delivering the desired fuel mixture into instructions that meters within the pump compartment of the fuel dispenser 100 can understand, as described above.

Alternatively, if the user has not chosen to apply any price discounts, the control module 112 can deliver the translated data 318′ can then be sent directly to the fuel controller 119. In some cases, the fuel controller 119 can send data to the forecourt controller 206 to inform the forecourt controller that it has received fueling instructions, and to update the status of the fuel dispenser so that an attendant can monitor and/or control the status of the fuel dispenser 100.

Data 320 characterizing the calculated unit price of the desire fuel mixture and/or the pricing information from the forecourt controller 206, or the POS system 208, can be authenticated and verified between the fuel controller 119 and the control module 112. For example, the control module 112 can sign data 320 characterizing the calculated unit price of the fuel mixture, and the fuel controller 119 can authenticate the signed data 320.

In some embodiments, the control module 112 can deliver data 322 to the display to prompt the user to initiate fueling after the calculated unit price of the desire fuel mixture and/or the pricing information from the forecourt controller 206, or the POS system 208, has been authenticated and verified between the fuel controller 119 and the control module 112. The user can enter a fueling initiation command on the display 120 or elsewhere on the dispenser, and data 324 characterizing the initiation command can be delivered to the control module 112. For example, in some embodiments the initiation command can be entered when a user depresses a lever on the nozzle 108 to begin fueling. The control module 112 can receive the data 324 characterizing the initiation command, translate the data 324, and send the translated data 326 characterizing the initiation command to the fuel controller 119.

The fuel controller 119 can receive the data 326, compute a response 328, and begin executing a process to dispense the fuel mixture. The fuel controller 119 can activate the pumps and send commands to the storage system 204 to dispense the desired components necessary to deliver the selected fuel grade.

During the dispensing process the fuel controller 119 can provide updates regarding a status of the dispensing by periodically sending data 330 characterizing the status of the dispensing to the control module 112. Alternatively, the control module 112 can fetch the data 330 from the fuel controller 119. As an example, the data 330 from the fuel controller 119 can characterize a total volume of the desired fuel mixture that has been dispensed and/or volumes of each component of the fuel mixture that have been dispensed, as well as a calculated total cost of dispensed fuel mixture based on the unit price of the fuel mixture and the total volume that has been dispensed. The control module 112 can receive the data 330 from the fuel controller 119, translate the data 330, and send data 332 characterizing the volume of fuel dispensed and the corresponding cost to the display 120 to be displayed. The data 332 can be used to update graphical elements, or graphical objects, of a GUI rendered on the display to provide information regarding cost and volume of the fuel mixture that has been dispensed to the user until dispensing is complete. In some embodiments, the fuel controller 119 can deliver data characterizing the volume of the fuel mixture that has been dispensed and/or volumes of each component of the fuel mixture that have been dispensed to the control module 112, and the control module 112 can calculate the total cost of the dispensed fuel mixture using the calculated unit price.

The user can send a “termination” command, via the display 120 or elsewhere on the fuel dispenser, at any time during the fueling process to abort fueling. The control module 112 will receive the command, translate it, and send it to the fuel controller 119 to abort fueling. For example, the termination command can be sent when the user releases a lever on the nozzle to stop fueling.

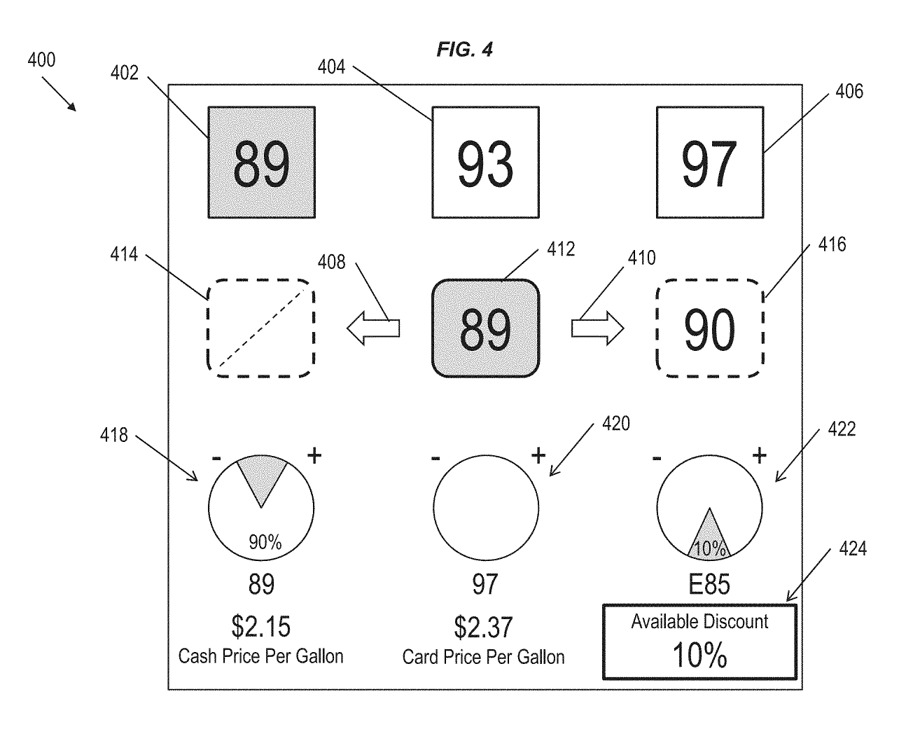

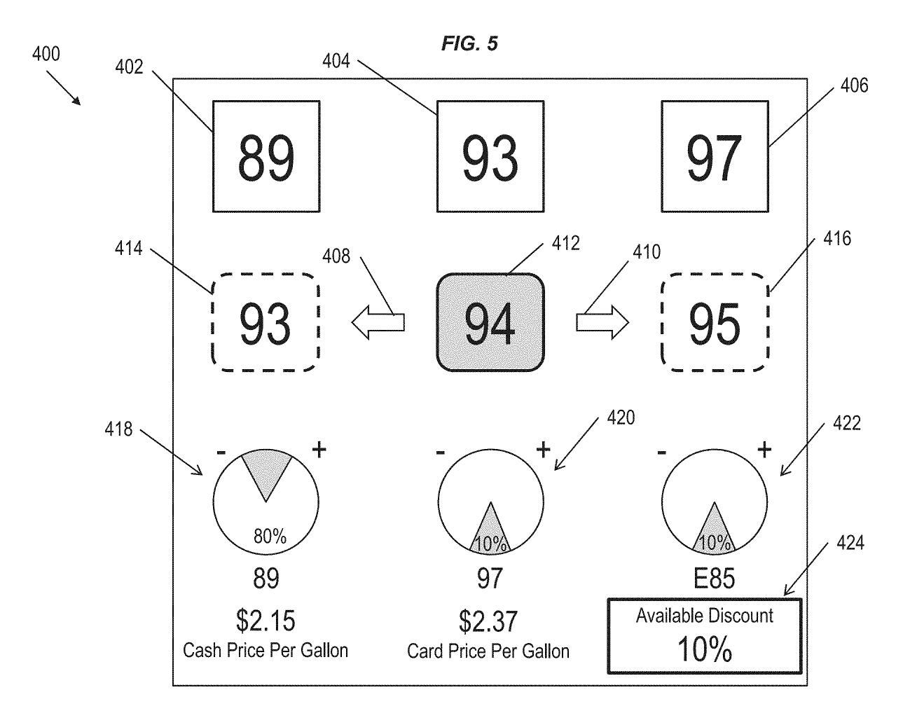

FIGS. 4-5 illustrate an exemplary interactive GUI 400 that can be rendered on a display such as, e.g., the display 120 described above with regard to FIGS. 1-3, and it can be configured to enable a user to create a customized fuel blend. The GUI 400 can be used to display data and receive user input as described above with regard to FIGS. 1-3. For example, the GUI 400, shown in FIG. 4, includes first, second, and third graphical elements 402, 404, 406 at the top that represent pre-set fuel grades, namely 89 octane, 93 octane, and 97 octane. The user can select any one of the pre-set grades as may be desired. In the illustrated example, the user has selected the 89 octane grade. The interface also includes fourth and fifth graphical elements, illustrated as first and second arrows 408, 410, that can be adjacent a sixth graphical element 412 that displays a currently selected octane grade, and can facilitate adjusting the octane grade. For example, a user can touch a portion of the display 120 corresponding to a location of the second arrow 410 to increase an amount of octane in the fuel mixture to a value displayed in a seventh graphical element 412 to the right of the second arrow 410. Alternatively, the user can touch a portion of the display 120 corresponding to a location to first arrow 408 to decrease the amount of octane in the fuel mixture to a value displayed in an eighth graphical element 414 to the left of the first arrow 408. Increases and decreases can occur incrementally allowing the user to select any grade within a range of available octane grades that the dispenser has the ability to provide. The range of available octane grades will be determined based on the minimum and maximum grade of fuel available in the storage tanks. As shown in FIG. 4, the graphical element 414 to the left of the first arrow 408 does not show an octane value because the selected “89” octane grade is the lowest available grade.

The interface can also be configured to allow a user to select a specified amount of each octane grade. For example, the interface can include ninth, tenth and eleventh graphical elements 418, 420, 422 that a user can interact with to adjust percentages of fuel components to create a desired fuel mixture. As shown in FIG. 4, the ninth and tenth graphical elements 418, 420 can be used to adjust amounts of 89 and 97 octane grade fuel, and the eleventh graphical element 422 can be used to adjust an amount of E85 fuel. As an example, the user can rotate a dial or touch plus and minus buttons of the ninth, tenth and eleventh graphical elements 418, 420, 422 to set a percentage for each of three grades to be present in the customized blend. Unit prices corresponding to cash and credit card payment methods are illustrated at the bottom of the GUI 400. A twelfth graphical element 424 can be used to apply a 10% discount to the unit price of the fuel.

FIG. 5 illustrates the percentages of each grade adjusted as compared to FIG. 4. For example, in FIG. 5, the octane grade is set at “94,” and the user can press the first arrow 408 to decrease the octane grade, or the second arrow 410 to increase the octane grade.

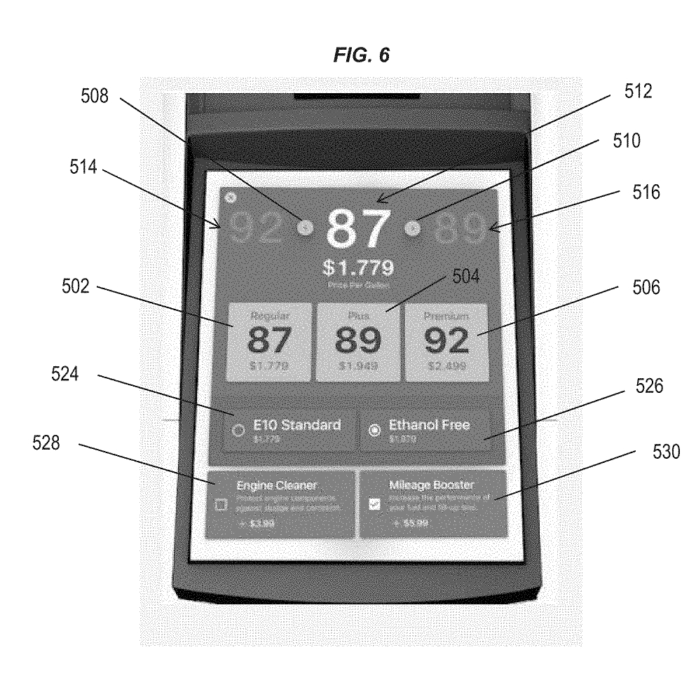

FIG. 6 shows another example of a GUI 500 that can be rendered on a display that can be similar to the display 120 described above with regard to FIGS. 1-3. As shown in FIG. 7, the GUI 500 can include graphical elements 502, 504, 506 that can be used t to select pre-set fuel grades, namely 87 octane, 89 octane, and 92 octane. The GUI 500 shows a currently selected octane grade “87” in a graphical element 512 near the top of the GUI 500, and includes graphical elements, illustrated as first and second arrows 508, 510 that can allow the user to switch to other available octane grades “92” and “89,” shown in graphical elements 514, 516 to the left and right of the first and second arrows 508, 510. The GUI 500 also provides options to switch to select E10 standard fuel or ethanol free fuel, shown in graphical elements 524, 526, which are below graphical elements 502, 504, 506 corresponding to the pre-set fuel grades. Additives such as an engine cleaner and/or a mileage booster can be selected using graphical elements 528, 530, respectively.

Although a few variations have been described in detail above, other modifications or additions are possible. As an example, a fuel dispenser can include in-dispenser payment terminal. Alternatively, the payment terminal can be a standalone outdoor payment terminal (OPT), or it can be a mobile device that can connect to the payment terminal 105 via a wired and/or wireless connection. For example, an outdoor payment terminal (OPT) can be in electronic communication with the fuel controller, but not integral with the fuel dispenser. In some embodiments, a display can be located on a mobile device, such as a smart phone, tablet, laptop, and the like, and can be in electronic communication with a control module such as, e.g., the control module 112, described above with regard to FIGS. 1-4, of a payment terminal that can be in that is in electronic communication with the fuel controller. As another example, the display can be located within the car itself, where it would function similarly to a smartphone, tablet, laptop, etc. In that event, a computer in the car could use diagnostic information, and send data characterizing the optimal fuel mixture to a control module of a payment terminal.

Additionally, a control module such as, e.g., the control module 112, described above, can also communicate with a network to send or receive data, for example, to get updates, transmit information, get information regarding the availability of ingredients, and the like, during, prior to, or after a fuel dispensing process is complete.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A fuel dispenser, comprising:
a pump compartment having at least one fuel pump disposed therein and configured to dispense fuel;
a fuel controller in operative communication with the pump compartment for controlling the at least one fuel pump; and
a payment terminal having
an interactive display configured to receive input thereon to enable a user to create a customized fuel blend, and
a control module configured to receive data that characterizes the customized fuel blend created by the user, to obtain pricing information relating to components of the customized fuel blend, compute a unit price for the customized fuel blend using the pricing information, generate instructions for creating the customized fuel blend, and transmit the instructions to the fuel controller for dispensing the customized fuel blend.

2. The fuel dispenser of claim 1, wherein the interactive display comprises a touchscreen.

3. The fuel dispenser of claim 1, wherein the control module is configured to receive data characterizing payment information from the interactive display, and to deliver the data characterizing payment information to a point-of-sale system for verification.

4. The fuel dispenser of claim 1, wherein the control module is configured to deliver data characterizing the unit price to the interactive display to update a graphical element of a graphical user interface rendered on the interactive display to display the unit price.

5. The fuel dispenser of claim 1, wherein the control module is configured to obtain the pricing information from a point-of-sale system.

6. The fuel dispenser of claim 1, wherein the payment terminal is configured to receive information from the fuel controller during the dispensing of the customized fuel blend, and to display data characterizing a current total price of the customized fuel blend dispensed.

7. A method for delivering fuel from a fuel dispenser, comprising:
displaying on an interactive display of a fuel dispenser at least one first graphical object for specifying a fuel blend;
receiving data characterizing a user input that identifies the fuel blend;
determining instructions for creating the fuel blend based on the received data, wherein the instructions identify at least two components of the fuel blend;
computing a unit value of the fuel blend using value information related to each of the at least two components of the fuel blend;
displaying on the interactive display at least one second graphical object comprising the computed unit value; and
transmitting the instructions to a fuel controller of the fuel dispenser for creating the fuel blend, the fuel controller being configured to control dispensing of the fuel blend from the fuel dispenser.

8. The method of claim 7, further comprising obtaining the value information from a point-of-sale system.

9. The method of claim 7, wherein the unit value of the fuel blend is computed by a control module of a payment terminal of the fuel dispenser.

10. The method of claim 7, further comprising transmitting data characterizing the unit value of the fuel blend from a control module of a payment terminal of the fuel dispenser to the fuel controller.

11. The method of claim 7, wherein at least one of the displaying, receiving, determining, and transmitting is performed by at least one data processor forming part of at least one computing system.

12. The method of claim 7, wherein the instructions for creating the fuel blend include percentages of the at least two components of the fuel blend.

13. The method of claim 7, wherein the at least one graphical object comprises three graphical objects that represent three different fuel grades, each fuel grade having a different octane level.

14. A non-transitory computer program product comprising computer readable instructions, which, when executed by at least one data processor forming part of at least one computing system, implement operations comprising:
displaying on an interactive display of a fuel dispenser at least one first graphical object for specifying a fuel blend;
receiving data characterizing a user input that identifies the fuel blend;
determining instructions for creating the fuel blend based on the received data, wherein the instructions identify at least two components of the fuel blend;
computing a unit value for the fuel blend using value information related to the at least two components of the fuel blend;
displaying on the interactive display at least one second graphical object for accepting the computed unit value; and
transmitting the instructions to a fuel controller in the fuel dispenser for creating the fuel blend, the fuel controller being configured to control dispensing of the fuel blend from the fuel dispenser.

15. The non-transitory computer program product of claim 14, the operations comprising obtaining the value information a point-of-sale system.

16. The non-transitory computer program product of claim 14, the operations comprising transmitting data characterizing the unit value of the fuel blend to the fuel controller.

17. The non-transitory computer program product of claim 14, wherein the at least one graphical object comprises three graphical objects that represent three different fuel grades, each fuel grade having a different octane level.

18. The non-transitory computer program product of claim 14, wherein the instructions for creating the fuel blend include a percentage of the at least two components of the fuel blend.

19. The non-transitory computer program product of claim 14, wherein the unit value of the fuel blend is computed by a control module of a payment terminal of the fuel dispenser.
